(19) United States
(12) Patent Application Publication
(10) Pub. No.: US 2008/0275845 A1
(43) Pub. Date: Nov. 6, 2008

(54) SYSTEM AND METHOD FOR SEARCHING IN A DISTRIBUTED ENVIRONMENT

(76) Inventors: Christian Schleimer, Mannheim (DE); Kai Schelkes, Hockenheim (DE)

Correspondence Address: SAP AG, 3410 HILLVIEW AVENUE, PALO ALTO, CA, 94304, US

(21) Appl. No.: 11/743,158

(22) Filed: May 2, 2007

(51) Int. Cl. G06F 17/30

(52) U.S. Cl. 707/3; 707/E17.014; 707/E17.032

(57) ABSTRACT

What is described is a method for searching in a distributed environment. The method includes receiving a query at a search module, triggering the search module to search content matching the query in a distributed environment. The distributed environment includes at least one of an internal database and an external database. Thereafter, retrieving the matched content at the search module as a search result, and transmitting the search result to a destination.

### FIELD OF THE INVENTION

The invention relates to an online procurement method. More particularly, the invention relates to a system and method for catalog search in a distributed environment.

### DESCRIPTION OF THE RELATED ART

With the proliferation of networked computer systems there has been an evolution of remote ordering using computing devices. The remote ordering includes remote identification of suppliers and/or products to be ordered.

Lack of supplier electronic product catalogs or electronic catalogs resident in buyer side procurement systems has created difficulties in automating procurement and supply chain processes in the buyer side procurement systems. Companies have implemented expensive buy-side applications for automation. However, only a fraction of their suppliers support such automation efforts because of requirement of substantial investment of both time and money. Thus, these companies may have only a few supplier electronic catalogs resident in buy-side procurement systems, out of thousands of available suppliers, limiting the number of transactions through these applications.

There are numerous manufacturers and distributors, who provide their product information to their customers via electronic catalogs. However, with multiple and disparate electronic catalog formats, syndication approaches, technologies and taxonomies available, only a minority of these suppliers have enough financial resources and technical skills to meet each customer's unique needs.

Although a majority of supplier web sites have basic product information and list pricing, they rarely meet buyer's requirements for aggregation and user interface standardization, buyer-specific attributes such as pricing, part numbers, and integration with buyer's electronic procurement system.

### SUMMARY OF THE INVENTION

What is described is a method for searching catalog content in a distributed environment. The method includes receiving a query at a search module, triggering the search module to search content matching the query in a distributed environment. The distributed environment includes at least one of an internal database and an external database. Thereafter, retrieving the matched content at the search module as a search result, and transmitting the search result to a destination.

### BRIEF DESCRIPTION OF THE DRAWINGS

The embodiments of the invention, together with its advantages, may be best understood from the following detailed description taken in conjunction with the accompanying figures in which:

FIG. 1 illustrates a method for searching catalog content according to an embodiment of the invention.

FIG. 2 illustrates a method for searching catalog content and creating a procurement cart according to an embodiment of the invention.

FIG. 3 illustrates structure of a search business application according to one embodiment of the present invention

FIG. 4 illustrates a block diagram for searching catalog information according to an embodiment of the invention.

FIG. 5 illustrates a block diagram for searching catalog information according to another embodiment of the invention.

FIG. 6 illustrates a block diagram of components according to an embodiment of the invention.

FIG. 7 illustrates a search result at a destination according to an embodiment of the invention.

### DETAILED DESCRIPTION

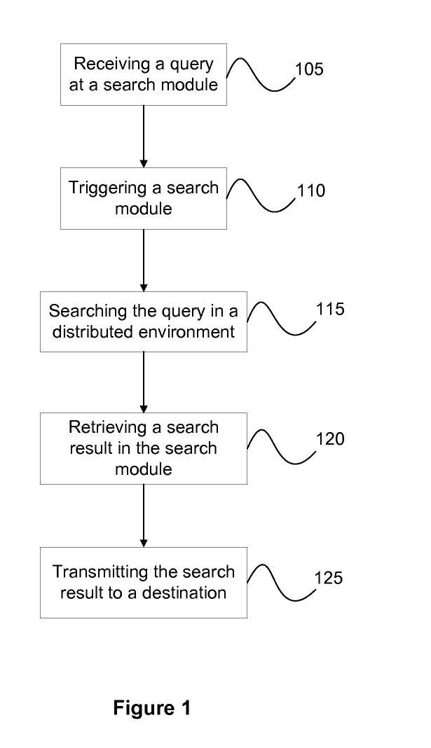

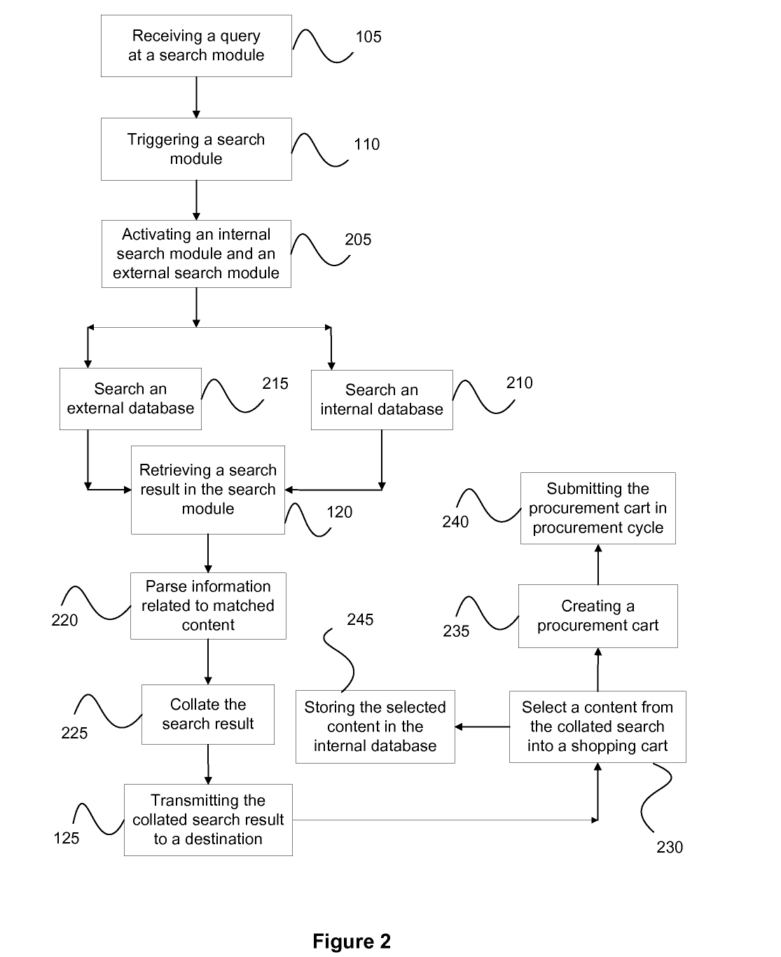

FIG. 1 and FIG. 2 illustrate different embodiments of a method for searching catalog information in a distributed environment. Referring initially to FIG. 1, at 105 a query is received at a search module. At 110, the search module is triggered to perform a search. At 115, the search module searches content matching the query in a distributed environment, wherein the distributed environment includes at least one of an internal database and an external database. At 120, the content in the internal database and the external database matching the query is retrieved as a search result. At 125, the search result is transmitted to a destination.

The query may use at least one of choosing a parameter from a menu method, a query by example method, and a query language method. In the parameter from the menu, the internal database and the external database present a list of parameters from which the user may choose the query. In the query by example, user may specify the input fields and values that define the query. In the query language, database requires user to make requests for information as a stylized query that is written in a special query language, such as structured query language.

The search module contains a query controller object, which defines relationship and interaction of the controller object with business objects. The query controller object encapsulates the query and query domain model. The domain model includes relationship of the query controller object with an internal query object and an external query object. The query object also includes a rule for triggering the search module to initiate the search. In addition, the query controller object handles the input event from the user interface, often via a handler.

The internal database contains at least one of a product master, a shopping cart template and a previous cart. The product master is a set of object instances of materials and services, which have an identifier in the buyer side procurement system. The shopping cart template has user defined preferred catalog content that are selected from the product master and connected catalogs such as a supplier catalog available on internet and a published supplier catalog. The preferred catalog content in the shopping cart template is associated with corresponding material and services in the product master and the connected catalogs via an interface such as an open catalog interface. The interface enables updating catalog content in the shopping cart template during runtime. The previous cart contains catalog content that the user used in the past. The user may include comments, remarks and user experience for a selected/used catalog content, which is contained in the previous cart. The catalog content in the product master, the shopping cart template, and the previous cart has a structure that is understandable by the search module. The external database contains at least one of a supplier catalog available on internet, and a published supplier catalog. The published supplier catalog includes catalog that is imported in the buyer side procurement system, but is in a structure that is not understandable by the search module. The catalog content contains details about products, services and suppliers.

The destination may include a user interface. The user interface may represent the catalog content of the search result as a selectable item representing an identification of the content, and locator address of the content. The search result is obtained from at least one of the internal database and the external database. Those skilled in the art may appreciate that other destinations such as a storage medium are also within the scope and spirit of the invention.

FIG. 2 illustrates additional details of one embodiment of the invention. At 205, the query controller object of the search module performs a first triggering to activate an internal search module and a second triggering to activate an external search module. As part of searching, the content matching the query is searched in the internal database at 210 and in the external database at 215.

The internal query object and the external query object are business objects that abstract the entities in a business object. For example, an order entry program needs to work with concepts such as orders, line items, invoices, and so on. Each of these may be represented by a business object. The internal query object and the external query object further comprise a domain model to represent relationships among such business objects and the controller object of the search module. The business object encapsulates data and behavior associated with the entity that the business object represents. For example, an order object is responsible for loading an order from a database, exposing or modifying any data associated with that order, that is, order number, and order's customer account, and saving the order back to the database.

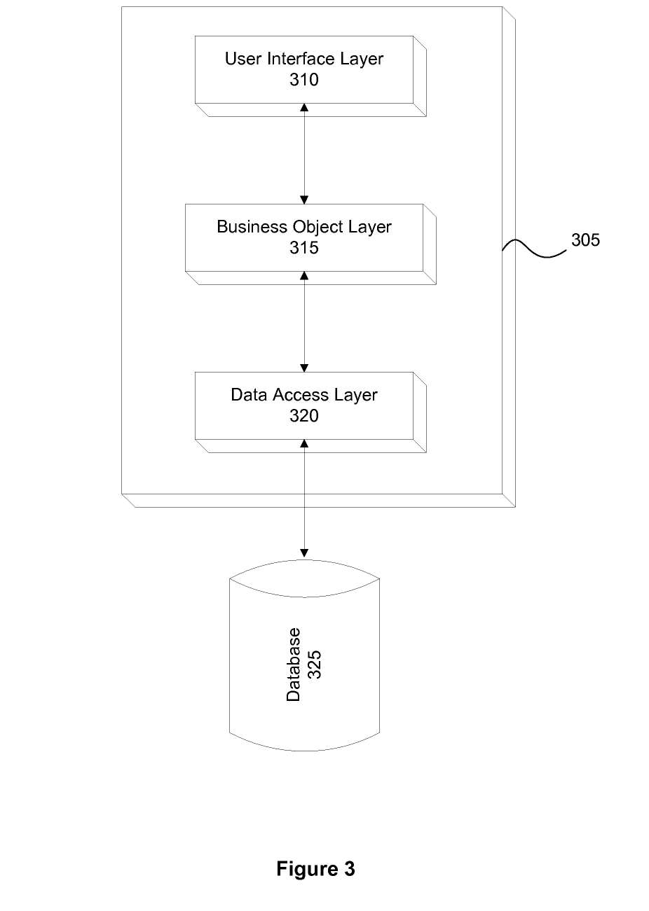

The internal search module contains the internal query object, which includes a rule for searching content matching the query in the internal database. The internal query object is associated with a data access layer (refer FIG. 3, 320). The data access layer enables searching catalog content matching the query in the internal database. Similarly, the external search module contains the external query object, which includes a rule for searching content matching the query in the external database. The external query object is associated with an interface. The interface enables searching catalog content matching the query in the external database. The data access layer and the interface are described in detail below.

The internal query object and the external query object create an internal controller object line item for the internal database and an external controller object line item for the external database. The internal controller object line item and the external controller object line item includes matched content from the internal database and the external database respectively. The matched content contained in the internal controller object line item and the external controller object line item is then sent to the controller object.

At 120, catalog content matching the query is retrieved as a search result at the search module. The retrieval includes retrieving the matched content from the internal database via the internal search module and from the external database via the external search module.

At 220, a parsing rule is applied on the matching content of the search result. The parsing rule parses the matched content for a set of information to generate a parsed search result. The parsing rule may include a rule indicating retrieving a set of information from the matched content such as supplier contact details, pricing, discount available, review, and item specification. Similarly, a collation rule to collate is applied to the parsed search result at 225, to generate a collated search result. The collating rule may include collating based on rule such as database from where the information is retrieved, pricing of the product, supplier name, fastest delivery, smallest delivery unit, and alphabetically sorting the items. Those of skill in the art may set different parsing rule and collating rule for the search. At 125, the collated search result is transmitted to the destination.

At 230, an item representing the information in the collated search result is selected and added into a shopping cart is selected. At 235, a procurement cart is created on confirmation of shopping cycle and at 240, the cart is submitted in a procurement cycle through a procurement cycle user interface. In addition, at 245, the query controller object updates the previous shopping cart with an entry of the selected item. This entry is available in the previous cart for future search. Through the procurement cycle user interface, the user may include comments, remarks and user experience for a selected/used catalog content, which is contained in the previous cart.

FIG. 3 illustrates structure of a search business application according to one embodiment of the present invention. Business application 305 includes a user interface layer 310, a business object layer 315 and a data access layer 320. In general, the layers provide for separation and modularization of functionalities and services of a software application. These functionalities are integrated into a single application via common communication links that allow data to be exchanged between any two layers. For example, the business object layer 315, which is used in part to define the functionality, structure and logic of an application, exists independently from the user interface layer 310, which provides functionality for displaying a user interface to the user. Since different devices have varying degrees of capabilities with respect to the various functionalities associated with these framework layers, the business application allows for flexible adaptation of a software application to accommodate the capabilities of various devices.

The user interface layer 310 provides functionality for presenting a computing user with a graphical user interface. For example, according to one embodiment, user interface layer may include a plurality of hypertext markup language or extensible markup language pages, which are fetched via a browser resident on the user computing device and presented to the user.

The user interface layer 310 may include an interaction layer, which provides functionality for responding to interactions between the user and the user interface layer 310. For example, the interaction layer may include logic for performing certain functions based upon a user clicking a particular portion of the user interface.

Business object layer 315 includes functionality for the core business logic underlying the application running on the computing device. According to one embodiment of the present invention, an application is modeled through domain model relationships. Business objects provide an abstraction of an underlying database 325 and thereby facilitate development of a business application to include common notions of business entities. Among other functions, business object layer 315 performs validations of data entered by a user. A modeler allows a developer to define business objects, business object properties, domain models, business rules (e.g., validation rules), which define the logic relating to particular business objects and business query modeling.

Data access layer 320 provides functionality for interactions with the database 325. The data access layer provides a communication link to relate particular business objects with corresponding tables and fields in the internal database 325 for searching. These tables and fields enable search of matching data in the database 325.

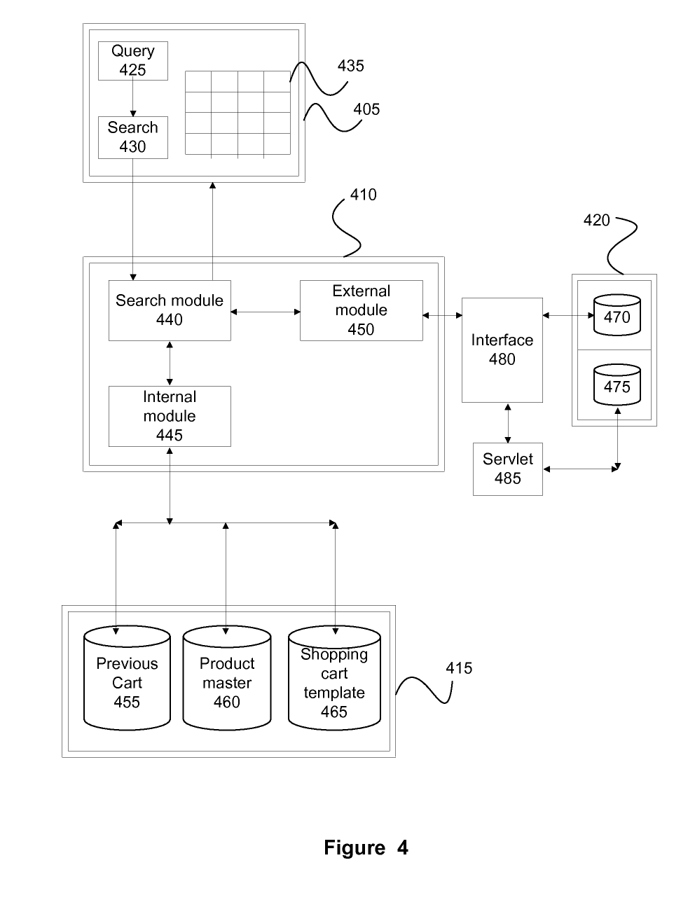

FIG. 4 illustrates a block diagram for searching catalog information according to an embodiment of the invention. 405 shows a user interface having a query area 425, where the user may enter a query value. A search agent 430 that associates the query value with a search module 440, which is contained in a search unit 410. The search module includes a query controller object, contained in the business object layer (refer FIG. 3, 315), that triggers the search module 440. The search module performs a search in distributed environment via an internal module 445 and an external module 450. The internal search module includes an internal query object that is associated with the data access layer (refer FIG. 3, 320). The external search module contains an external object query associated with an interface 480, which enables access to the external database. The interface enables translating the query from a search unit understandable structure to external database understandable structure.

The distributed environment includes an internal database 415 and an external database 420. The internal database includes at least one of a product master 460, a shopping cart template 465 and a previous cart 455. The internal module sends the query to the internal database as an internal request via the data access layer and determines matching record for the query.

Similarly, the external module sends the query as a hypertext transfer protocol request via the interface to the external database and determines matching record for the query. The external database includes at least one of a supplier catalog 470 available on internet, and a published supplier catalog 475. The external module accesses the published supplier catalog 475 is accessed via the interface, and a servlet 485.

The internal query object and the external query object of the internal search module and the external search module searches for catalog content matching the query in the internal database and the external database. The search module retrieves the matched content as a search result via the internal search module and the external search module. The interface translates the matched content retrieved from the external database from the external database understandable structure to the search module understandable structure. The search module applies a parsing rule on the matching content of the search result. The parsing rule parses the matched content for a set of information to generate a parsed search result. Similarly, the search module applies a collation rule to collate the parsed search result and to generate a collated search result. Then, the collated search result 435 is transmitted to the destination 405.

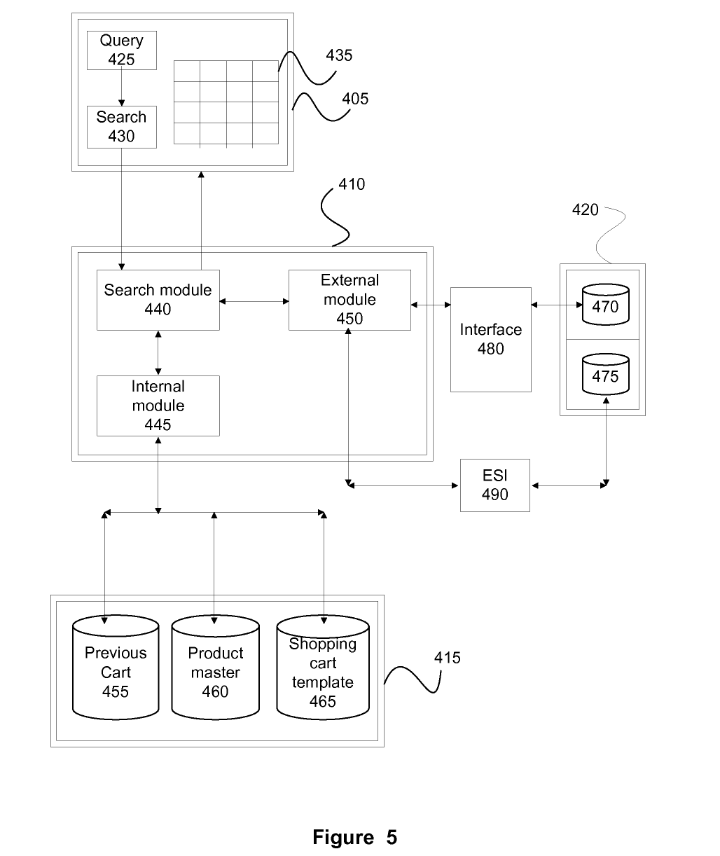

FIG. 5 illustrates a block diagram for searching catalog information according to another embodiment of the invention. The external module 450 directly connects to an enterprise service infrastructure 490. The enterprise services infrastructure connects, mediates, controls and monitors communication between the external module and the published catalog and supports and optimizes the search. The communication between the external search module 450 and the published catalog content 475 is enterprise service infrastructure compliant. The matched content in the external database is retrieved in the search module via the enterprise service infrastructure and the external module. The search module parses the search result for a set of information, which is then collated to generate a collated search result. The collated search result 435 is then transmitted to the destination.

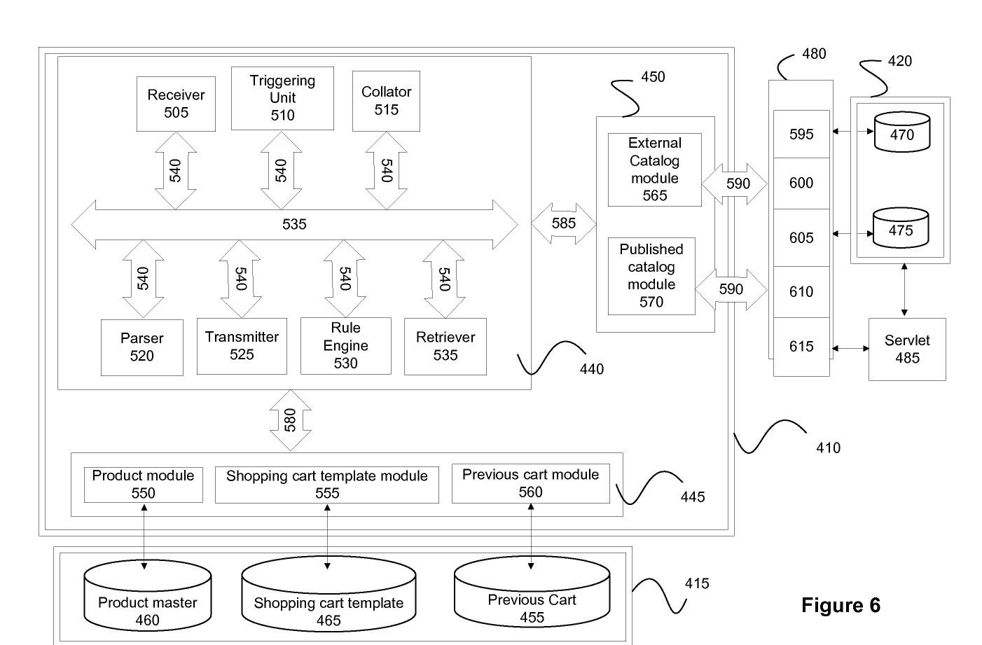

FIG. 6 illustrates a block diagram of components according to an embodiment of the invention. The components include the search module 440, the internal search module 445, the external search module 450, and the interface 480. The search module 440 includes a receiver 505 to receive a query at the search module. A triggering unit 510 to trigger the search module and to send the query to the internal search module 445 and the external search module 450. The triggering module further performs a first triggering and a second triggering that activates the internal search module and the external search module respectively.

The internal search module includes a product module 550, a shopping cart template module 555 and a previous cart module 560 to search content matching the query in a product master 460, a shopping cart template 465, and a previous cart 455 respectively. Each of the product module, the shopping cart template module and the previous cart module accesses the data in respective database via the data access layer (refer FIG. 3, 320). The data access layer provides a communication link to relate respective business object of the product module, the shopping cart template module and the previous cart module with corresponding tables and fields of respective internal database. The internal query object includes the business object of respective business object of the product module, the shopping cart template module and the previous cart module. The tables and fields of the internal database enable search of matching content for the query in the internal database. The matched content from the internal database is retrieved in respective business object line item of the product module 550, the shopping cart template module 555 and the previous cart module 560 and sent to the search module.

Similarly, the external module contains an external catalog module 565, and a published catalog module 570 to search the supplier catalog 470 available on internet, and a published supplier catalog 475 respectively. The external query object includes the business object of respective external catalog module, and the published catalog module. The external search module accesses the external database and searches the matching content via an interface 480. The interface enables translating the query from a search unit understandable structure to external database understandable structure. The matched content from the external database is retrieved in respective business object line item of the external catalog module 565, and the published catalog module 570 and sent to the search module.

The internal query object and the external query object has respective domain models, which defines rules of communication, searching and retrieval from the internal database and external database respectively.

The interface 480 implements various programming models, and establishes connections, communication, and translation functions to enable communication between the external search module and external database. The interface connects the external search module and manages the communication of the external search module with the external database. Such interfaces include published extensible markup language interfaces such as commerce extensible markup language and open catalog interface.

The interface includes a module connection layer 595 to set an external module connection with the interface, a module communication layer 600 to manage the module connection, a translation layer 605 to translate the query from a module understandable structure to an external database understandable structure. The content of the query remains constant through the translation. Similarly, matched content accessed from the external database is translated from external database understandable structure to external module understandable structure and the content of the matched content retrieved remain constant. A database connection layer 615 to set an external database connection and a database communication layer 615 to manage the external database connection. The connection layers 595 and 615 perform specific startup and shutdown routines. The communication layers 600 and 610 perform communication management and may include error logging, transaction coordination and application data polling.

The retriever 535 of the search module retrieves the matched content from the internal database 415 and the external database 420 via line items of each of the internal module 445 and the external module 450 as a search result. Based on a parsing rule, a parser 520 parses the matched content for a set of information to generate a parsed search result. Similarly, based on a collating rule, a collator 515 collates the parsed search result and generates a collated search result. Then, a transmitter 525 transmits the collated search result to a destination.

A rule engine 530 is also included in the search module, which sets the parsing rule as well as the collating rule. The parsing rule may include a rule indicating retrieving a set of information from the matched content such as supplier contact details, pricing, discount available, review, and item specification. The collating rule may include collating based on a rule such as database from where the information is retrieved, pricing of the product, supplier name and alphabetically sorting the items. Those of skill in the art may set different parsing rule and collating rule for the search.

Sub-components within the search module may communicate among one another via communication channels 535 and 540. Similarly, the search module communicates with the internal search module via communication channel 580 and with the external search module via communication channel 585. In addition, sub-components of the external search module communicate with the interface via communication channel 590.

In another embodiment, the published catalog content is directly connected to the external module via an enterprise service infrastructure.

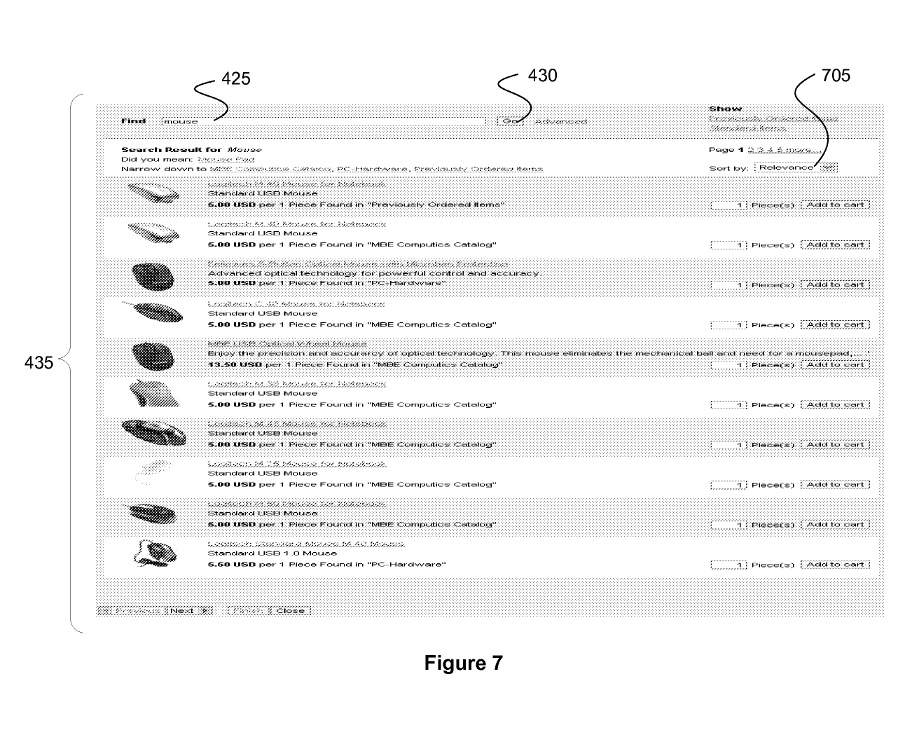

FIG. 7 illustrates a search result at a destination according to an embodiment of the invention. A query value mouse is entered in the query area 425 and the search agent 430 enables a search. The search result 435 shows a set of matched content with an identification of the content, and locator address of the content. The locator information indicates the databases where the matched content was found. In addition, sorting agent 705 provides means for sorting the search result. Those of skill in the art will recognize that many other representation of the search result is via a user interface are possible and fully within the scope and spirit of this disclosure.

Other embodiments of the invention may be implemented in digital electronic circuitry, or in computer hardware, firmware, software, or in combinations of them.

Elements of the invention may also be provided as a machine-readable medium for storing the machine-executable instructions. The machine-readable medium may include, but is not limited to, Flash memory, optical disks, CD-ROMs, DVD ROMs, RAMs, EPROMs, EEPROMs, magnetic or optical cards, propagation media or other type of machine-readable media suitable for storing electronic instructions.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Throughout the foregoing description, for the purposes of explanation, numerous specific details were set forth in order to provide a thorough understanding of the invention. It will be apparent, however, to one skilled in the art that the invention may be practiced without some of these specific details. The underlying principles of the invention may be employed using a virtually unlimited number of different types of input data and associated actions.

Accordingly, the scope and spirit of the invention should be judged in terms of the claims which follow.

What is claimed is:

1. A method comprising:
receiving a query at a search module;
triggering the search module to search content matching the query in a distributed environment having at least one of an internal database and an external database;
retrieving the matched content at the search module as a search result; and
transmitting the search result to a destination.

2. The method of claim 1, wherein the content comprises a catalog content.

3. The method of claim 1, wherein:
the internal database is selected from a group consisting at least one of a product master record, a shopping cart template, and a previous cart; and
the external database comprises a group consisting at least one of a supplier catalog available over internet, and a published supplier catalog.

4. The method of claim 1, wherein triggering comprises:
a first triggering of an internal module to search the internal database; and
a second triggering of an external module to search the external database.

5. The method of claim 4, wherein the internal module sends the query to the internal database as an internal request to search content matching the query in the internal database.

6. The method of claim 4, wherein the external module sends the query to the external database as a hypertext transfer protocol request to search content matching the query in the external database.

7. The method of claim 1, wherein retrieving comprises parsing the matched content to generate a set of information that includes at least an identification of the content, and locator address of the content.

8. The method of claim 1, further comprising collating the matched content according to a collating rule to generate a collated search result.

9. An article of manufacture, comprising:
a machine readable medium that provides instructions, which when executed by a machine, causes the machine to:
receive a query at a search module;
trigger the search module to search content matching the query in a distributed environment having at least one of an internal database and an external database;
retrieve the matched content at the search module as a search result; and
transmit the search result to a destination.

10. The medium of claim 9, wherein the machine readable medium provides instructions, which when executed by a machine, causes the machine to:
first trigger an internal module in the search module to search the internal database; and
second trigger an external module in the search module to search the external database.

11. The medium of claim 10, wherein the machine readable medium provides instructions, which when executed by a machine, causes the machine to send the query from the internal module to the internal database as an internal request to search content matching the query in the internal database.

12. The medium of claim 10, wherein the machine readable medium provides instructions, which when executed by a machine, causes the machine to send the query from the external module to the external database as a hypertext transfer protocol request to search content matching the query in the external database.

13. The medium of claim 9, wherein the machine readable medium provides instructions, which when executed by a machine, causes the machine to parse the matched content to generate a set of information that includes at least an identification of the content and locator address of the content.

14. The medium of claim 9, wherein the machine readable medium provides instructions, which when executed by a machine, causes the machine to collating the matched content to generate a collated search result.

15. A system comprising:
a receiver to receive a query;
a triggering unit to trigger a search module to search content matching the query in a distributed environment having at least one of an internal database and an external database;
a retriever to retrieve the matched content at the search module as a search result; and
a transmitter to transmit the search result to a destination.

16. The system of claim 15, wherein the triggering unit:
first triggers an internal module in the search module to search the internal database; and
second triggers an external module in the search module to search the external database.

17. The system of claim 15, further comprising an interface to provide communication between the external search module and the external database.

18. The system of claim 15, further comprising a rule engine to set a parsing rule and a collating rule.

19. The system of claim 15, further comprising a parser to parser the matched content according to a parsing rule to generate a set of information that includes at least an identification of the content and locator address of the content.

20. The system of claim 15, further comprising a collator to collate the matched content according to a collating rule to generate a collated search result.
